(19) United States
(12) Patent Application Publication
(10) Pub. No.: US 2026/0093089 A1
(43) Pub. Date: Apr. 2, 2026

(54) METHOD FOR OPERATING AN OPTICAL SYSTEM, AND OPTICAL SYSTEM

(71) Applicant: Carl Zeiss SMT GmbH, Oberkochen (DE)

(72) Inventors: Robin LINTEN, Aalen (DE); Norman BAER, Aalen (DE); Maike LORENZ, Aalen (DE); Martin VON HODENBERG, Oberkochen (DE)

(21) Appl. No.: 19/410,650

(22) Filed: Dec. 5, 2025

Related U.S. Application Data
(63) Continuation of application No. PCT/EP2024/057144, filed on Mar. 18, 2024.

(30) Foreign Application Priority Data
Jun. 23, 2023 (DE) 10 2023 205 964.9

(51) Int. Cl. G02B 7/18

(52) U.S. Cl. CPC G02B 7/1815

(57) ABSTRACT

An optical system, such as in a microlithographic projection exposure apparatus, comprises at least one mirror having an optical active surface and a mirror substrate made of a mirror substrate material. At least one cooling channel is provided in the mirror substrate through which a cooling fluid with a variably settable cooling-fluid temperature can flow. In a method of operating an optical system, the cooling-fluid temperature is set on the basis of an existing deviation between an actual value for the average zero-crossing temperature of the coefficient of thermal expansion of the mirror substrate material and a predefined setpoint for this average zero-crossing temperature. The cooling-fluid temperature is controlled during operation of the optical system. The control is effected on the basis of a feedforward model.

### CROSS-REFERENCE TO RELATED APPLICATIONS

The present application is a continuation of, and claims benefit under 35 USC 120 to, international application No. PCT/EP2024/057144, filed Mar. 18, 2024, which claims benefit under 35 USC 119 of German Application No. 10 2023 205 964.9, filed Jun. 23, 2023. The entire disclosure of each of these applications is incorporated by reference herein.

### FIELD

The disclosure relates to a method for operating an optical system and to an optical system, such as in a microlithographic projection exposure apparatus.

### BACKGROUND

Microlithography is used for producing microstructured components, such as for example integrated circuits or LCDs. The microlithography process is carried out in what is referred to as a projection exposure apparatus, which comprises an illumination device and a projection lens. The image of a mask (=reticle) illuminated via the illumination device is projected here via the projection lens onto a substrate (e.g. a silicon wafer) coated with a light-sensitive layer (photoresist) and arranged in the image plane of the projection lens, in order to transfer the mask structure to the light-sensitive coating of the substrate.

In projection lenses designed for the EUV range, i.e. at wavelengths of for example approximately 13 nm or approximately 7 nm, mirrors are used as optical components for the imaging process owing to the general lack of availability of suitable light-transmissive refractive materials.

In practice, as a result of absorption of the radiation emitted by the EUV light source among other reasons, the EUV mirrors can heat up and undergo an associated thermal expansion or deformation, which in turn can adversely affect the imaging properties of the optical system. Various approaches are known for avoiding surface deformations caused by inputs of heat into an EUV mirror and optical aberrations associated with such deformations.

It is known inter alia to use a material with ultra-low thermal expansion (“Ultra Low Expansion Material”), for example a titanium quartz glass sold by Corning Inc. with the name ULE™, as the mirror substrate material and to set what is known as the Zero-Crossing Temperature in an area near the optically effective surface. At this zero-crossing temperature, which is approximately 9=30° C. for example for ULE™, the coefficient of thermal expansion has in its temperature dependence a zero crossing in the vicinity of which the sensitivity to changes in temperature or local variations in temperature is low.

Other possible approaches for avoiding surface deformations caused by inputs of heat into an EUV mirror include active direct cooling or the use of a heating arrangement, for example on the basis of infrared radiation. With such a heating arrangement, active mirror heating can take place in phases of comparatively low absorption of EUV used radiation, the active mirror heating being correspondingly decreased as the absorption of the EUV used radiation increases. The active heating of the mirror can be carried out for example with the aim of keeping the average mirror temperature close to the abovementioned zero-crossing temperature.

In practice, however, among other things the actual zero-crossing temperature of the mirror substrate material used can differ from the originally desired or required zero-crossing temperature in general owing to the manufacturing process or corresponds thereto only within a manufacturing-related tolerance, a possible result of which ultimately is a significant contribution to the thermally induced wavefront aberrations. Also acting on the relevant mirror, in addition to the absorption of the radiation emitted by the EUV light source, are thermal loads caused by components (e.g. actuators) or structures (e.g. supporting frames) that are present elsewhere in the optical system and may be insufficiently cooled.

Reference is made merely by way of example to WO 2022/161659 A1 and WO 2022/028710 A1.

### SUMMARY

The present disclosure seeks to provide a method for operating an optical system and an optical system which make it possible to effectively avoid thermally induced deformations whilst at least alleviating certain known undesirable features.

According to one aspect, the disclosure relates to a method for operating an optical system, wherein the optical system comprises at least one mirror, which has an optical active surface and a mirror substrate made of a mirror substrate material, wherein provided in the mirror substrate is at least one cooling channel through which a cooling fluid with a variably settable cooling-fluid temperature can flow.

In this method, the cooling-fluid temperature is set on the basis of an existing deviation between an actual value (ZCT2) for the average zero-crossing temperature of the coefficient of thermal expansion of the mirror substrate material and a predefined setpoint (ZCT1) for this average zero-crossing temperature, wherein the cooling-fluid temperature is controlled during operation of the optical system, and wherein this control is effected on the basis of a feedforward model.

The disclosure includes the consideration that, even in approaches that are widespread in practice, in which mirror substrate materials with ultra-low thermal expansion are used with the aim of operating the relevant mirrors at the zero-crossing temperature (ZCT=“Zero-Crossing Temperature”), the actual (real) value for this zero-crossing temperature for the mirror substrate material used does not always correspond to the actually expected or “assumed” setpoint (e.g. the setpoint ordered from the manufacturer) for the zero-crossing temperature, e.g. due to manufacturing-related tolerances or deviations, with the result that the performance of the associated optical system can be significantly adversely affected without suitable measures.

Taking this into consideration, the disclosure includes transferring the relevant mirror into a thermal state adapted to the mirror substrate material actually used or its actual zero-crossing temperature, by suitably setting the cooling-fluid temperature of the cooling fluid flowing through the at least one cooling channel. In other words, the influence exerted on the optical performance of the optical system by the existing deviation between the actual value and the setpoint of the zero-crossing temperature of the mirror substrate material is at least partially compensated. Due to the adaptation according to the disclosure of the cooling-fluid temperature, the relevant mirror can be in a temperature range which corresponds to the optimum temperature band for the actual zero-crossing temperature of the mirror substrate material used, with the result that thermally induced deformations or aberrations in the relevant mirror that occur during operation of the optical system can be minimized again in a desired manner.

The present disclosure provides accepting the fact that there are manufacturing-related deviations in the zero-crossing temperature of the mirror substrate material as such, but at the same time actively utilizing the cooling fluid that is flowing in the mirror substrate material in any case, or its cooling-fluid temperature, in order to at least partially eliminate the undesirable effects of these deviations on the performance of the optical system.

According to the disclosure, the cooling-fluid temperature is controlled during operation of the optical system, wherein this control is effected based on a feedforward model.

Since, in addition to the setting according to the disclosure of the cooling-fluid temperature for adaptation to existing material deviations in the mirror substrate material with regard to the zero-crossing temperature, a control of the cooling-fluid temperature is also effected during operation of the optical system, it is possible to take into account the fact that, during operation of the associated optical system, the exposure of the relevant mirror to used light (e.g. EUV radiation) is also associated with an input of heat, which can be conjointly taken into account via the setting and control according to the disclosure of the cooling-fluid temperature.

The disclosure further also relates to a method for operating an optical system, wherein the optical system comprises at least one mirror, which has an optical active surface and a mirror substrate made of a mirror substrate material, wherein provided in the mirror substrate is at least one cooling channel through which a cooling fluid with a variably settable cooling-fluid temperature can flow, wherein the cooling-fluid temperature is set on the basis of an existing deviation between an actual value (ZCT2) for the average zero-crossing temperature of the coefficient of thermal expansion of the mirror substrate material and a predefined setpoint (ZCT1) for this average zero-crossing temperature.

According to one embodiment, the cooling-fluid temperature is set in such a way that a contribution to the wavefront aberrations thermally induced during operation of the optical system, this contribution being caused by the deviation between the actual value (ZCT2) and the setpoint (ZCT1) for the average zero-crossing temperature of the coefficient of thermal expansion of the mirror substrate material, is at least partially compensated.

According to one embodiment, the cooling fluid temperature is set taking into account a predefined usage scenario for the optical system, such as with regard to a reticle used, an illumination setting used and/or a light source power used.

According to one embodiment, heat energy is additionally input-coupled into the mirror via a heating device. The combination setting the cooling-fluid temperature with the separately known approach of active mirror heating by input-coupling heat energy from a heating device (which in turn can be generated e.g. via infrared radiation heaters or resistive heating elements to which electrical current can be applied) can mean—again based on generally unavoidable deviations between the actual value and the setpoint of the zero-crossing temperature of the mirror substrate material used—that the heating device is in this respect “unburdened” of taking into account or compensating for these deviations. Since specifically the optimum thermal state, taking into account the actual zero-crossing temperature of the mirror substrate material used, of the mirror (to some extent a “basic state”) can already be set via the adaptation according to the disclosure of the cooling-fluid temperature, only the respective “travel” needs to be set via the heating device, in order to achieve the effects desired from the active mirror heating (typically a local and/or temporal homogenization of the temperature profile of the mirror to avoid thermally induced aberrations). The heating power from the relevant heating device to achieve the effect desired from the active mirror heating can therefore be significantly reduced, since the issue of existing material deviations in the mirror substrate material with regard to the zero-crossing temperature is taken into account by adapting the cooling-fluid temperature within the framework of the concept according to the disclosure.

In embodiments of the disclosure, the control can also be effected on the basis of a variable characteristic of the thermal load acting on the mirror or of the current heating state of the mirror, such as on the basis of measured values for the cooling-fluid temperature or on the basis of sensor values supplied by at least one temperature sensor provided on the mirror.

According to one embodiment, the mirror is designed for an operating wavelength of less than 30 nm, such as less than 15 nm.

According to one embodiment, the optical system is an illumination device or a projection lens of a microlithographic projection exposure apparatus.

The disclosure further relates to an optical system comprising at least one mirror which has an optical active surface and a mirror substrate, wherein provided in the mirror substrate is at least one cooling channel through which a cooling fluid with a variably settable cooling-fluid temperature can flow. The optical system includes a device for setting the cooling-fluid temperature on the basis of an existing deviation between an actual value (ZCT2) for the average zero-crossing temperature of the coefficient of thermal expansion of the mirror substrate material and a predefined setpoint (ZCT1) for this average zero-crossing temperature, wherein the optical system is designed to control the cooling-fluid temperature, and wherein this control is effected on the basis of a feedforward model.

According to one embodiment, the optical system is configured to carry out a method having the features described above.

Further embodiments of the disclosure can be gathered from the description and the dependent claims.

The disclosure will be explained in greater detail below on the basis of exemplary embodiments illustrated in the appended figures.

### BRIEF DESCRIPTION OF THE DRAWINGS

In the figures:

FIG. 1 shows a schematic illustration for elucidating the possible structure of a mirror according to one embodiment of the disclosure;

FIG. 2 shows a schematic illustration for elucidating a principle disclosed in the present disclosure;

FIG. 3 shows a schematic illustration for elucidating a mode of operation of the disclosure; and

FIG. 4 shows a schematic illustration of a possible structure of a microlithographic projection exposure apparatus designed for operation in the EUV.

### DETAILED DESCRIPTION

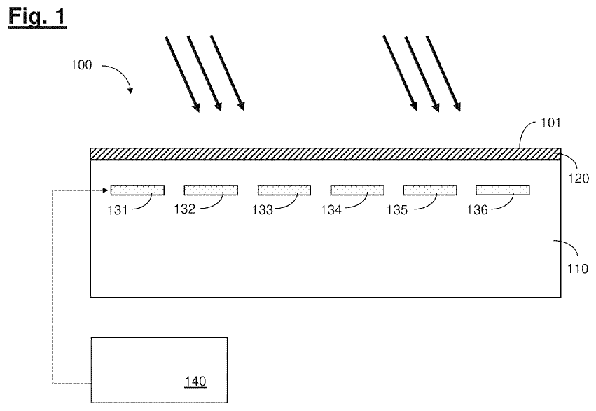

The following text describes exemplary embodiments of the disclosure on the basis of the merely schematic illustrations, i.e. diagrams, of FIGS. 1-4. These embodiments include that, during operation of a mirror or an optical system comprising it, the cooling-fluid temperature of a cooling fluid flowing through at least one cooling channel within the mirror substrate is set, in order to take into account an existing, typically manufacturing-related deviation of the average Zero-Crossing Temperature (ZCT) of the actually desired setpoint (e.g. the setpoint “ordered” from the manufacturer).

FIG. 1 shows a merely schematic illustration of one possible embodiment of a mirror according to the disclosure. The mirror 100 has a mirror substrate 110 (e.g. made of ULE™) and a reflection layer system 120 (e.g. in the form of a molybdenum (Mo)-silicon (Si) multilayer coating stack). As also indicated in FIG. 1, the mirror substrate contains at least one cooling channel through which a cooling fluid (e.g. cooling water) with a variably settable cooling-fluid temperature can flow. In the exemplary embodiment (without the disclosure being limited thereto), a plurality of cooling channels 131-136 is provided. In further embodiments, it is also possible for only one (e.g. meandering) cooling channel to be provided. 140 denotes a device for setting the cooling-fluid temperature in the at least one cooling channel. The cooling-channel arrangement can be used to counteract, for example, in a known manner that is knowns, a heating of the mirror caused by used light (e.g. EUV radiation) being incident on the mirror 100 or its optical effective surface, denoted by 101.

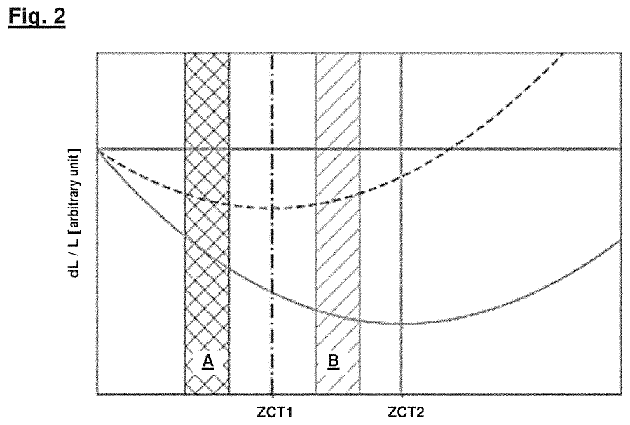

According to the above-mentioned concept according to the disclosure, the cooling-channel arrangement is now additionally used to transfer, as indicated in the diagram of FIG. 2, the mirror 100 into a thermal state adapted to the mirror substrate material used or its actual zero-crossing temperature ZCT2—which, as already mentioned, generally deviates from the actually desired zero-crossing temperature or the setpoint ZCT1 therefor for manufacturing-related reasons.

In FIG. 2, “A” denotes the range, for average temperatures that are set owing to the absorption of the used light (e.g. EUV radiation) incident on the optical effective surface 101, for the setpoint ZCT1 for the zero-crossing temperature. The difference, which can be seen in FIG. 2, between the setpoint ZCT1 and the range A is caused, among other things, by the fact that, depending on the illumination setting or intensity distribution of the used radiation incident on the mirror 100, possibly significant location-dependent variations of the (e.g. EUV-related) thermal load on the mirror 100 may occur, the zero-crossing temperature then being selected for example such that the thermal expansion is minimal within the range of the highest intensities or maximum temperatures that arise. This “pair” consisting of the range A at expected average temperatures and the value ZCT1 of the zero-crossing temperature is then shifted as already mentioned for the actually used mirror substrate material in the diagram of FIG. 2 inasmuch as the actual (real) value of the zero-crossing temperature ZCT2 and the associated range “B” of average temperatures for which the zero-crossing temperature ZCT2 would be optimal are at comparatively higher temperatures.

To this end, the adaptation according to the disclosure of the cooling-fluid temperature causes the mirror 100 or the mirror substrate 110 to be transferred into the corresponding thermal state which is provided by virtue of the fact that the average radiation-related temperatures set due to the incident used radiation (e.g. EUV radiation) lie in the range “B” (matching the actual zero-crossing temperature ZCT2 of the mirror substrate material) and not in the range “A” (corresponding to the actually expected, but not actually provided zero-crossing temperature ZCT1).

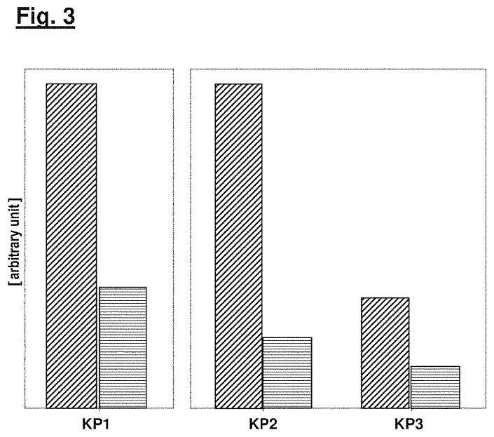

FIG. 3 shows a schematic illustration for elucidating the mode of operation of the disclosure. In this case, for each of three exemplary optical systems, each having a mirror according to the disclosure for its optical properties or performance, in characteristic variables (“key parameters”) KP1-KP3, the respective left-hand bar represents the maximum over the tolerance band in the case without the cooling-fluid temperature being adapted according to the disclosure to the actual zero-crossing temperature ZCT2 of the mirror substrate material, whereas the respective right-hand bar applies in the case of adaptation according to the disclosure to the actual zero-crossing temperature ZCT2 of the mirror substrate material. In the example shown, the performance in the characteristic variables KP1-KP3 is improved by a factor of about 2 to 3 in each case.

According to the disclosure of the present application, it is possible to take into account the existing deviation between the setpoint and the actual value of the zero-crossing temperature of the mirror substrate material by setting the cooling-fluid temperature, i.e. the cooling-fluid temperature is set on the basis of the previously determined deviation between the setpoint and the actual value of the zero-crossing temperature and then kept at the corresponding value.

In embodiments of the present disclosure, the cooling-fluid temperature is controlled during operation of the mirror 100 or the optical system comprising it (for example beyond the setting of the cooling-fluid temperature). For example, the input of heat from the used radiation incident on the mirror or its optical active surface (e.g. EUV radiation) can be taken into account. In other words, the thermal load which arises during operation of the optical system and typically varies over time can be taken into account by controlling the cooling-fluid temperature.

In embodiments of the disclosure, this control is effected on the basis of a feedforward model, for example on the basis of a feedforward model for the temperatures in the mirror substrate and in the cooling fluid.

The control can also be effected for example on the basis of measured data from a temperature sensor for determining the cooling-fluid temperature at the cooling-channel outlet, measured data from temperature sensors in or on the mirror substrate or in the surrounding area, or on the basis of measured data regarding the optical aberrations occurring in the optical system (e.g., the wavefront provided by the optical system in a certain plane).

During the setting according to the disclosure of the cooling-fluid temperature, in addition to the deviation between the actual value and the setpoint for the zero-crossing temperature, further factors or parameters of the respective current usage scenario, such as the power of the existing light source in the optical system, a respective currently set illumination setting and/or a reticle used in the optical system can be taken into account.

The setting or control according to the disclosure of the cooling-fluid temperature can but does not necessarily have to be effected toward a determined value of the temperature of the cooling fluid at the cooling-channel inlet (as target value or control variable). In further embodiments, the setting or control can also be effected toward a different temperature, e.g. to a temperature measured on the mirror or in the mirror substrate or in the cooling-fluid lines with the assistance of a sensor, a mean temperature across a determined area (e.g. the optical active surface) or a determined volume, etc., it being possible to implement this in a simulation or using a thermal imaging camera.

In embodiments, a mirror can be heated in a known way via a heating device (e.g. radiation-based heating device or heating device comprising resistive heating elements), typically to take into account or to compensate for local variations and/or variations over time in the thermal load, or the temperature distribution becoming established in the mirror. This can mean that in that case the corresponding heating device only has to apply the desired “mirror heating travel” for the compensation of local variations and/or variations over time in the thermal load, whereas the transfer according to the disclosure of the mirror into the thermal “basic state” according to the actual zero-crossing temperature ZCT2 of the mirror substrate material is already effected via the adaptation of the cooling-fluid temperature.

In embodiments, the adaptation or variation effected within the scope of the disclosure of the cooling-fluid temperature can also be used to at least partially compensate for external heat sources. This can take account of the fact that, in addition to the thermal load caused by incident used light (e.g. EUV radiation), the temperature of the relevant mirror and thus also thermally induced deformations and resulting wavefront aberrations are influenced by further components in the optical system, e.g. actuators, heating devices of other mirrors, mount elements, apertures, etc., which generally can cause the mirror temperature to increase. According to the disclosure, this effect can also be at least partially compensated by reducing the cooling-fluid temperature.

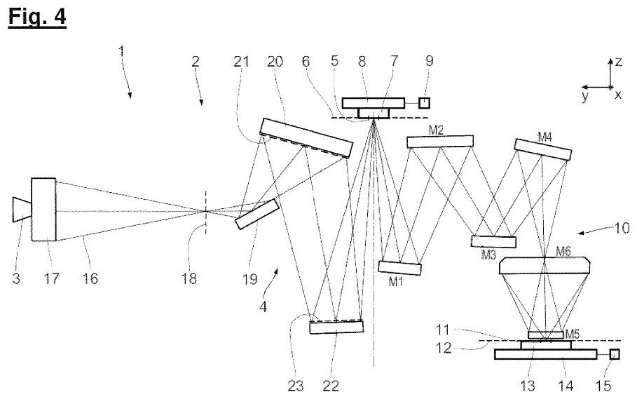

FIG. 4 first of all schematically shows a meridional section through the possible structure of a microlithographic projection exposure apparatus designed for operation in the EUV.

According to FIG. 4, the projection exposure apparatus 1 comprises an illumination device 2 and a projection lens 10. One embodiment of the illumination device 2 of the projection exposure apparatus 1 has, in addition to a light or radiation source 3, an illumination optical unit 4 for illuminating an object field 5 in an object plane 6. In an alternative embodiment, the light source 3 may also be provided as a module separate from the rest of the illumination device. In this case, the illumination device does not comprise the light source 3.

In this case, a reticle 7 arranged in the object field 5 is exposed. The reticle 7 is held by a reticle holder 8. The reticle holder 8 is displaceable for example in a scanning direction by way of a reticle displacement drive 9. For explanatory purposes, a Cartesian xyz-coordinate system is depicted in FIG. 4. The x-direction runs perpendicularly into the plane of the drawing. The y-direction runs horizontally, and the z-direction runs vertically. The scanning direction runs in the y-direction in FIG. 4. The z-direction runs perpendicularly in relation to the object plane 6.

The projection lens 10 serves for imaging the object field 5 into an image field 11 in an image plane 12. A structure on the reticle 7 is imaged onto a light-sensitive layer of a wafer 13 arranged in the region of the image field 11 in the image plane 12. The wafer 13 is held by a wafer holder 14. The wafer holder 14 is displaceable by way of a wafer displacement drive 15 for example in the y-direction. The displacement on the one hand of the reticle 7 by way of the reticle displacement drive 9 and on the other hand of the wafer 13 by way of the wafer displacement drive 15 can take place in such a way as to be synchronized with one another.

The radiation source 3 is an EUV radiation source. The radiation source 3 emits EUV radiation, which is also referred to below as used radiation or illumination radiation. For example, the used radiation has a wavelength in the range of between 5 nm and 30 nm. The radiation source 3 can be for example a plasma source, a synchrotron-based radiation source or a free electron laser (FEL). The illumination radiation 16 emanating from the radiation source 3 is focused by a collector 17 and propagates through an intermediate focus in an intermediate focal plane 18 into the illumination optical unit 4. The illumination optical unit 4 comprises a deflection mirror 19 and, arranged downstream thereof in the beam path, a first facet mirror 20 (having schematically indicated facets 21) and a second facet mirror 22 (having schematically indicated facets 23).

The projection lens 10 comprises a plurality of mirrors Mi (i=1, 2, . . . ), which are consecutively numbered according to their arrangement in the beam path of the projection exposure apparatus 1. In the example illustrated in FIG. 4, the projection lens comprises six mirrors M1 to M6. Alternatives with four, eight, ten, twelve or any other number of mirrors Mi are also possible. The penultimate mirror M5 and the last mirror M6 each have a through-opening for the illumination radiation 16. The projection lens 10 is a doubly obscured optical unit. The projection lens 10 has an image-side numerical aperture which, merely by way of example (and without the disclosure being restricted thereto), can be greater than 0.5, such as more than 0.6 or more than 0.7.

During operation of the microlithographic projection exposure apparatus 1, the electromagnetic radiation incident on the optical effective surface of the mirrors is partially absorbed and, as explained in the introduction, results in heating and an associated thermal expansion or deformation, which in turn can result in the imaging properties of the optical system being adversely affected. The concept according to the disclosure can be applied to any desired mirror of the microlithographic projection exposure apparatus 1 from FIG. 4.

The disclosure is not restricted to use in a projection exposure apparatus designed for operation in the EUV. For example, the disclosure can also be used in a projection exposure apparatus designed for operation in the DUV (i.e. at wavelengths less than 250 nm, such as less than 200 nm) or in another optical system.

Even though the disclosure has been described on the basis of specific embodiments, numerous variations and alternative embodiments will be apparent to a person skilled in the art, for example by combining and/or exchanging features of individual embodiments. Accordingly, it is understood by those skilled in the art that such variations and alternative embodiments are also comprised by the present disclosure, and the scope of the disclosure is limited only within the meaning of the appended claims and their equivalents.

What is claimed is:

1. A method of operating an optical system, the optical system comprising a mirror, the mirror comprising an optical active surface and a mirror substrate, the mirror substrate comprising a mirror substrate material, the mirror substrate comprising a cooling channel configured to have a cooling fluid flow therethrough, the method comprising:
setting a temperature of the cooling fluid based on an existing deviation between an actual value for the average zero-crossing temperature of a coefficient of thermal expansion of the mirror substrate material and a predefined setpoint for the average zero-crossing temperature of the coefficient of thermal expansion of the mirror substrate material; and
controlling the temperature of the cooling fluid during operation of the optical system using a of a feedforward model.

2. The method of claim 1, comprising setting the temperature of the cooling fluid to at least partially compensate for a deviation-related contribution to thermally induced wavefront aberrations during operation of the optical system.

3. The method of claim 1, wherein setting the temperature of the cooling fluid comprises taking into account a predefined usage scenario of the optical system.

4. The method of claim 1, wherein the temperature of the cooling fluid is set with regard to a reticle used during operation of the optical system.

5. The method of claim 1, wherein the temperature of the cooling fluid is with regard to an illumination setting used during operation of the optical system.

6. The method of claim 1, wherein the cooling-fluid temperature is set with regard to a light source power used during operation of the optical system.

7. The method of claim 1, further comprising applying heat energy to the mirror using a heating device.

8. The method of claim 1, wherein controlling the temperature of the cooling fluid is based on a determination of a variable characteristic of: i) a thermal load acting on the mirror; or ii) a current heating state of the mirror.

9. The method of claim 8, wherein controlling the temperature of the cooling fluid is based on measured values of the temperature of the cooling fluid.

10. The method of claim 8, wherein controlling the temperature of the cooling fluid is based on sensor values supplied by a temperature sensor on the mirror.

11. The method of claim 1, wherein the mirror is configured to be used at an operating wavelength of less than 30 nm.

12. The method of claim 1, wherein the optical system comprises an illumination device of a microlithographic projection exposure apparatus, or the optical system comprises a projection lens of a microlithographic projection exposure apparatus.

13. The method of claim 1, comprising setting the temperature of the cooling fluid to at least partially compensate for a deviation-related contribution to thermally induced wavefront aberrations during operation of the optical system, wherein setting the temperature of the cooling fluid comprises taking into account a predefined usage scenario of the optical system.

14. The method of claim 1, comprising setting the temperature of the cooling fluid to at least partially compensate for a deviation-related contribution to thermally induced wavefront aberrations during operation of the optical system, wherein the temperature of the cooling fluid is set with regard to a reticle used during operation of the optical system.

15. The method of claim 1, comprising setting the temperature of the cooling fluid to at least partially compensate for a deviation-related contribution to thermally induced wavefront aberrations during operation of the optical system, wherein the temperature of the cooling fluid is with regard to an illumination setting used during operation of the optical system.

16. The method of claim 1, comprising setting the temperature of the cooling fluid to at least partially compensate for a deviation-related contribution to thermally induced wavefront aberrations during operation of the optical system, wherein the cooling-fluid temperature is set with regard to a light source power used during operation of the optical system.

17. The method of claim 1, comprising setting the temperature of the cooling fluid to at least partially compensate for a deviation-related contribution to thermally induced wavefront aberrations during operation of the optical system, wherein the method further comprises applying heat energy to the mirror using a heating device.

18. The method of claim 1, comprising setting the temperature of the cooling fluid to at least partially compensate for a deviation-related contribution to thermally induced wavefront aberrations during operation of the optical system, wherein controlling the temperature of the cooling fluid is based on a determination of a variable characteristic of: i) a thermal load acting on the mirror; or ii) a current heating state of the mirror.

19. An optical system, comprising:
a mirror comprising an optical active surface and a mirror substrate, the mirror substrate comprising a mirror substrate material, the mirror substrate material comprising cooling channel configured to have a cooling fluid flow therethrough temperature can flow; and
a device configured to set a temperature of the cooling fluid based on an existing deviation between an actual value of an average zero-crossing temperature of a coefficient of thermal expansion of the mirror substrate material and a predefined setpoint of the average zero-crossing temperature of the coefficient of thermal expansion of the mirror substrate material,
wherein the optical system is configured to control the temperature of the cooling fluid based on a feedforward model.

20. The optical system of claim 19, wherein the optical system comprises an illumination device of a microlithographic projection exposure apparatus, or the optical system comprises a projection lens of a microlithographic projection exposure apparatus.
